(19) United States
(12) Patent Application Publication
(10) Pub. No.: US 2014/0067654 A1
(43) Pub. Date: Mar. 6, 2014

(54) Apparatus and Method for the Electronic Transfer of Balances Between Accounts

(71) Applicants: Carrie A. Hanson, Charlotte, NC (US); Hitesh Bajaj, Johns Creek, GA (US); Laura C. Bondesen, Charlotte, NC (US); Nicole Chen, San Francisco, CA (US); Scott R. Enscoe, Waxhaw, NC (US); David M. Grigg, Rock Hill, SC (US); Leo Kopelow, San Francisco, CA (US); Yameng Li, Berkeley, CA (US); Brett Newman, Burlingame, CA (US); Sarah Overcash, Charlotte, NC (US); Nicholas Sharp, San Francisco, CA (US); Marc L. Warshawsky, Davidson, NC (US); Alexander C. Wittkowski, Charlotte, NC (US); Jon R. Wolf, Charlotte, NC (US)

(72) Inventors: Carrie A. Hanson, Charlotte, NC (US); Hitesh Bajaj, Johns Creek, GA (US); Laura C. Bondesen, Charlotte, NC (US); Nicole Chen, San Francisco, CA (US); Scott R. Enscoe, Waxhaw, NC (US); David M. Grigg, Rock Hill, SC (US); Leo Kopelow, San Francisco, CA (US); Yameng Li, Berkeley, CA (US); Brett Newman, Burlingame, CA (US); Sarah Overcash, Charlotte, NC (US); Nicholas Sharp, San Francisco, CA (US); Marc L. Warshawsky, Davidson, NC (US); Alexander C. Wittkowski, Charlotte, NC (US); Jon R. Wolf, Charlotte, NC (US)

(73) Assignee: Bank of America Corporation, Charlotte, NC (US)

(21) Appl. No.: 13/603,019

(22) Filed: Sep. 4, 2012

(51) Int. Cl. G06Q 20/10

(52) U.S. Cl. 705/39

(57) ABSTRACT

According to one embodiment, an apparatus may store a plurality of accounts. The apparatus may present, in a first region of a display, information associated with a first account in the plurality of accounts; in a second region of the display, information associated with a second account in the plurality of accounts; and in a third region of the display, a plurality of transfer amounts. The apparatus may detect a touch on the third region of the display indicating a selection of a transfer amount from the plurality of transfer amounts. The apparatus may communicate, in response to the detection of the touch, a message to initiate the transfer of the selected transfer amount from the first account to the second account.

### TECHNICAL FIELD

This disclosure relates generally to an apparatus for the electronic transfer of balances between accounts.

### BACKGROUND

As the use of mobile devices grows, so has the desire to shift, to the mobile devices, tasks typically performed using other devices such as a personal computer. However, for certain tasks that have been traditionally performed on other devices, it may be difficult to encourage the user to perform the tasks on the mobile device. In order to encourage users, institutions should provide users with incentives to perform tasks on the mobile device.

### SUMMARY OF THE DISCLOSURE

According to one embodiment, an apparatus may store a plurality of accounts. The apparatus may present, in a first region of a display, information associated with a first account in the plurality of accounts; in a second region of the display, information associated with a second account in the plurality of accounts; and in a third region of the display, a plurality of transfer amounts. The apparatus may detect a touch on the third region of the display indicating a selection of a transfer amount from the plurality of transfer amounts. The apparatus may communicate, in response to the detection of the touch, a message to initiate the transfer of the selected transfer amount from the first account to the second account.

Certain embodiments may provide one or more technical advantages. A technical advantage of one embodiment includes decreased processing power. Another technical advantage of one embodiment includes increased network throughput. Certain embodiments may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present disclosure and its features and advantages, reference is now made to the following description, taken in conjunction with the accompanying drawings, in which:

FIG. 1 illustrates a system for transferring balances between accounts;

FIG. 2 illustrates an embodiment of a mobile device used in FIG. 1;

FIG. 3 illustrates an embodiment of a mobile device used in FIG. 1;

FIG. 4 illustrates an embodiment of a mobile device used in FIG. 1;

FIG. 5 illustrates an embodiment of a mobile device used in FIG. 1;

FIG. 6 illustrates an embodiment of a mobile device used in FIG. 1;

FIG. 7 is a flowchart illustrating a method of electronically transferring balances between accounts.

### DETAILED DESCRIPTION

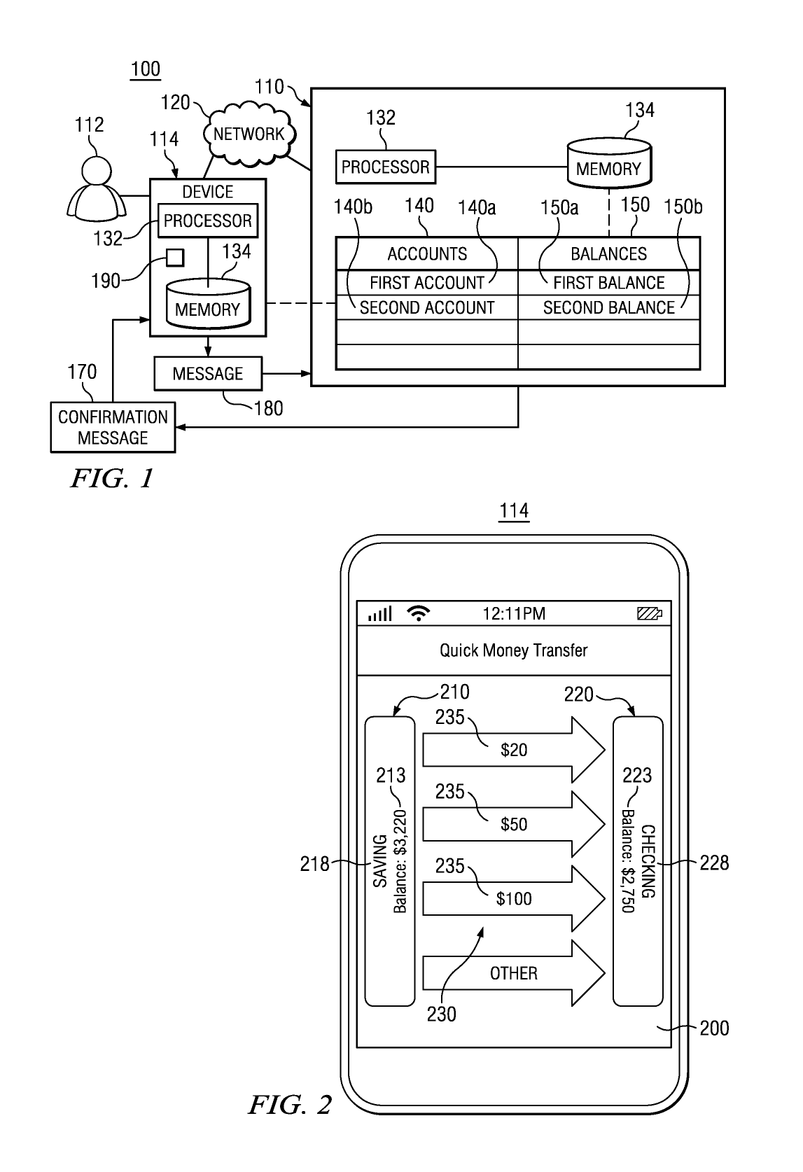

FIG. 1 illustrates a system 100 for transferring balances 150 between accounts 140. As provided by FIG. 1, system 100 includes a device 114, network 120, and server 110. Device 114 may be communicatively coupled to server 110 through network 120.

Generally, a user 112 may use device 114 to electronically transfer balances between accounts. Device 114 provides an interface through which user 112 can select two accounts and an amount of money to transfer between the two accounts. The user 112 can make this selection by touching or swiping a touchscreen of device 114. When device 114 detects the touch or swipe, it can determine whether the user 112 has sufficient funds in the accounts to perform the balance transfer. For example, if user 112 indicates that he wants to transfer $50 from an account that only has $25 in it, device 114 may deny the transfer. If there are sufficient funds, device 114 may initiate the transfer of funds by communicating with a server 110 that maintains the accounts. By using device 114 to transfer balances, network load may be reduced and processing power may be conserved.

In particular embodiments, server 110 may be configured to store accounts 140 and corresponding balances 150 and to transfer balances 150 between accounts 140. Server 110 may include a processor 132 and a memory 134. The functions of server 110 described herein may be performed by processor 132 and/or memory 134.

Memory 134 may be configured to store accounts 140 and corresponding balances 150. Memory 134 may store, either permanently or temporarily, data, operational software, or other information for processor 132. Memory 134 may include any one or a combination of volatile or non-volatile local or remote devices suitable for storing information. For example, memory 134 may include random access memory (RAM), read only memory (ROM), magnetic storage devices, optical storage devices, or any other suitable information storage device or a combination of these devices.

Processor 132 may be configured to handle transactions 180 associated with accounts 140 and balances 150. In particular embodiments, processor 132 may be configured to receive transactions 180 from device 114. Transactions 180 may request that a particular amount be transferred from a balance 150 of a first account to a balance 150 of a second account 140. Processor 132 may determine whether the balance 150 of the first account 140 is sufficient to transfer the amount to the balance 150 of the second account 140. Processor 132 may then transfer the amount from the balance 150 of the first account 140 to the balance 150 of the second account 140. In particular embodiments, processor 132 may generate a confirmation message 170 indicating that the transfer was successful. Processor 132 may send confirmation message 170 to device 114.

Processor 132 may control the operation and administration of server 110 by processing information received from network 120 and memory 134. Processor 132 may include any hardware and/or software that operates to control and process information. Processor 132 may be a programmable logic device, a microcontroller, a microprocessor, any suitable processing device, or any suitable combination of the preceding.

System 100 may include network 120. Device 114 may communicate with server 110 through network 120. Server 110 may communicate with external server 160 through network 120. This disclosure contemplates any suitable network 120 operable to facilitate communication between the components of system 100. Network 120 may include any interconnecting system capable of transmitting audio, video, signals, data, messages, or any combination of the preceding. Network 120 may include all or a portion of a public switched telephone network (PSTN), a public or private data network, a local area network (LAN), a metropolitan area network (MAN), a wide area network (WAN), a local, regional, or global communication or computer network, such as the Internet, a wireline or wireless network, an enterprise intranet, or any other suitable communication link, including combinations thereof, operable to facilitate communication between the components.

System 100 may include device 114. Device 114 may be communicatively coupled to server 110 through network 120. In particular embodiments, device 114 may provide user 112 an interface through which user 112 may quickly transfer balances 150 between accounts 140. User 112 may use device 114 to initiate a transfer of balances 150. In particular embodiments, device 114 may send a message 180 indicating that user 112 has requested a transfer of a balance 150 associated with a first account 140 to a balance 150 associated with a second account 140. Device 114 may send a message 180 to server 110 through network 120. Device 114 may receive a confirmation message 170 indicating that the transfer of balance 150 from a first account 140 to a second account 140 succeeded or failed. Device 114 may receive confirmation message 170 from server 110.

In particular embodiments, device 114 may include a processor and memory akin to the processor 132 and memory 134 of server 110. The memory of device 114 may be configured to store accounts 140 and balances 150 of user 112. In this manner, device 114 may check and analyze the balances 150 of accounts 140 of user 112 without having to request information from server 110. The processor of device 114 may be configured to control a display of device 114. In particular embodiments, the processor of device 114 may present on the display an interface through which user 112 can efficiently transfer money between accounts 140. The processor of device 114 may further generate and communicate messages with server 110.

In particular embodiments, device 114 may be a mobile device 114. Device 114 may be associated with user 112. For example, user 112 may be the owner of device 114. Device 114 may execute an application 190. The application 190 may provide user 112 an interface through which user 112 can select the amount of money to transfer between accounts 140. Application 190, when executed, may cause device 114 to perform the functions described herein. Device 114 may include a processor 132 and memory 134. Memory 134 may store the instructions or software for the application 190 and processor 132 may execute the instructions.

Device 114 may be a personal computer, a workstation, a laptop, a wireless or cellular telephone, an electronic notebook, a personal digital assistant, a tablet, or any other device (wireless, wireline, or otherwise) capable of receiving, processing, storing, and/or communicating information with other components of system 100. Device 114 may also include a user interface, such as a display, a touchscreen, a microphone, keypad, or other appropriate terminal equipment usable by user 112.

In operation, system 100 may provide a faster and more convenient way for user 112 to transfer money between accounts 140. User 112 may select the accounts 140 between which money is to be transferred and the amount to be transferred. After device 114 detects that user 112 has selected an amount to be transferred between accounts 140, device 114 may send a message 180 to server 110 through network 120. The message 180 may include information about the accounts 140 involved in the balance transfer and the amount to be transferred. For example, if user 112 selects to transfer $50 from his savings account to his checking account, message 180 may include the account numbers of the savings account and the checking account, identification information associated with user 112, and the transfer amount of $50.

When server 110 receives message 180, server 110 may determine that the balance 150a of the first account 140a is sufficient to transfer the amount of money to the second account 140b. If the balance 150a is sufficient, server 110 may continue to transfer the amount from the first account 140 to the second account 140. If the balance 150a is insufficient, server 110 may deny the transfer. For example, when server 110 receives the message 180 indicating user 112 wants to transfer $50 from his savings account to his checking account, server 110 may determine whether there are $50 in the user's 112 savings account. If not, server may deny the transfer. If the savings account has at least $50 in it, server 110 may perform the transfer.

Server 110 may then generate a message 170 indicating whether the transfer succeeded or failed. The message 170 may include information about the accounts in the transfer as well as a status. For example, if server 110 successfully transferred $50 from the user's 112 saving account to his checking account, the message 170 may include the account types checking and savings as well as the status: SUCCESSFUL. Although this disclosure describes the message 170 including particular account information and statuses, this disclosure contemplates message 170 including any appropriate account information and status. Server 110 may then send the message 170 to device 114 through network 120. After device 114 receives the message 170, device 114 may present, on a display, an indicating to the user whether the transfer has succeeded or failed.

In particular embodiments, system 100 provides user 112 with an intuitive and fast interface through which to transfer balances between accounts 140. In this manner, system 100 may encourage and incentivize users 112 to overcome any fears or concerns with respect to using device 114 to transfer balances between accounts 140. Furthermore, in particular embodiments, device 114 may be a mobile device 114, which may require less processing power to present an interface to user 112 and to initiate the balance transfer than a workstation or a personal computer. Additionally, mobile device 114 may execute application 190 to initiate the balance transfer, which may generate less network traffic than a workstation or a personal computer performing the same operations, thus improving network efficiency by reducing load.

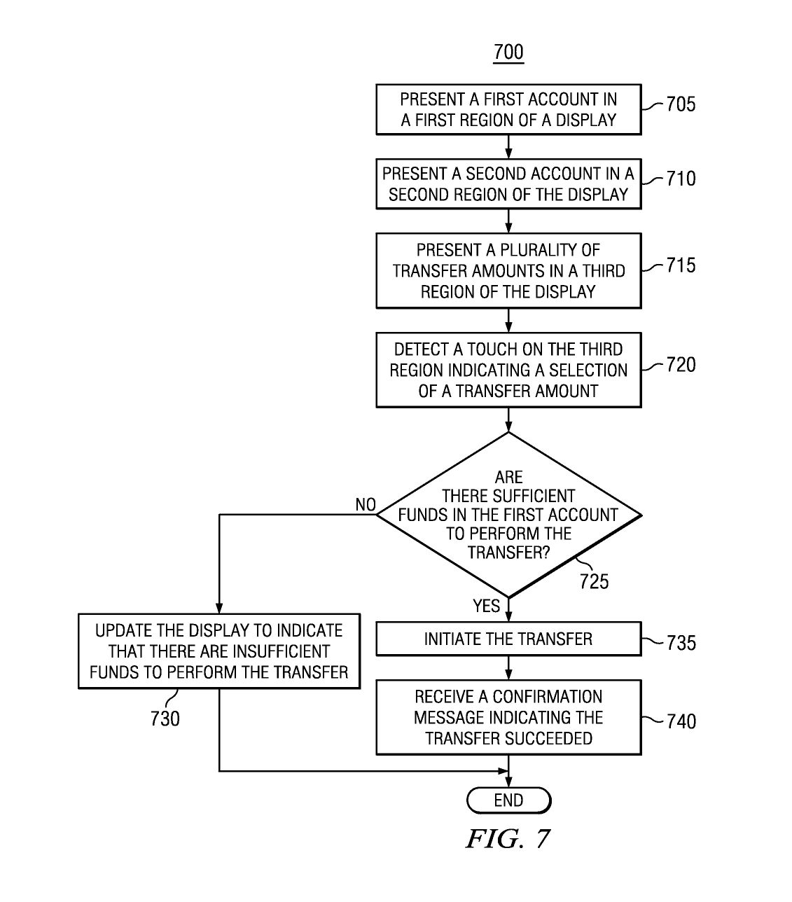

FIGS. 2 through 6 illustrate embodiments of the device 114 of FIG. 1. The embodiments provide different interfaces through which user 112 can initiate the transfer of balances from one account 140 to another. FIG. 7 illustrates a method of transferring balances that may be performed by device 114.

FIG. 2 illustrates an embodiment of a mobile device 114 used in FIG. 1. As provided by FIG. 2, device 114 may be a mobile device 114 that includes a display 200. Display 200 may include a touchscreen. User 112 may indicate selections by touching particular regions of display 200. For example, display 200 may present a button and user 112 may indicate a selection or push of the button by touching the region of the display 200 that presents the button. In particular embodiments, display 200 may present items in a first region 210, second region 220, and third region 230. User 112 may touch these regions of display 200 to indicate different selections. This disclosure contemplates any suitable number and arrangement of regions in which different components of electronic balance transfers may be implemented.

In the first region 210 of display 200, mobile device 114 may present information associated with a first account 140a. The first account 140a may be associated with an account type 218 and an account balance 213. In the example illustrated in FIG. 2, the first account is a savings account with a balance of $3,220.

In the second region 220 of display 200, mobile device 114 may present a second account 140b. The second account 140b may be associated with an account type 228 and an account balance 223. In the example illustrated in FIG. 2, the second account is a checking account with a balance of $2,750.

In the third region 230 of display 200, mobile device 114 may present a plurality of transfer amounts 235. The third region may lie in between the first region 210 and the second region 220. In the example illustrated in FIG. 2, the transfer amounts 235 include $20, $50, and $100. Moreover, in the third region 230 of display 200, mobile device 114 presents items indicating how user 112 can make a selection. In the example illustrated in FIG. 2, mobile device 114 presents a plurality of arrows corresponding to the transfer amounts 235. These arrows indicate that user 112 can transfer a particular amount of money from the savings account to the checking account by swiping over an arrow in the direction of the arrow. For example, user 112 may transfer $20 from the savings account to the checking account by swiping from the left side to the right side of the arrow corresponding to the transfer amount 235 of $20. This disclosure contemplates any suitable symbol, graphic, or text corresponding to the transfer amounts 235 presented on display 200, such as for example, buttons, radio buttons, and textboxes.

When mobile device 114 detects that user 112 has swiped over a particular transfer amount 235, mobile device 114 may determine that the first account has sufficient funds to be transferred to the second account. For example, if mobile device 114 detects the user has selected to transfer $100 from a first account that only contains $75, then mobile device 114 may deny the transfer. Mobile device 114 may further update display 200 to indicate that the transfer was denied due to insufficient funds. However, if mobile device 114 determines that there are sufficient funds to transfer the selected transfer amount 235 from the first account to the second account, mobile device 114 may communicate a message 180 to server 110 to initiate the transfer.

In particular embodiments, mobile device 114 additionally presents an option titled “other.” User 112 may swipe over the “other” option. When mobile device 114 detects that user 112 has selected the other option, mobile device 114 may update the display 200 to present an interface through which user 112 may input a transfer amount 235 of the user's 112 choosing. After user 112 enters the transfer amount 235, mobile device 114 may determine whether there are sufficient funds in the first account 140a as described above. Mobile device 114 may then deny or initiate the transfer.

In particular embodiments, device 114 may store frequent transactions performed using device 114. For example, device 114 may store that device 114 is frequently used to transfer funds from a saving account to a checking account. Device 114 may use this information to determine which accounts 140 to present in the first region 210 and the second region 210 of display 200. For example, device 114 may determine, based on the frequent transactions from the saving account to the checking account, that the default accounts to present on display 200 are the saving account in the first region of the display 200 and the checking account in the second region 220 of the display 200.

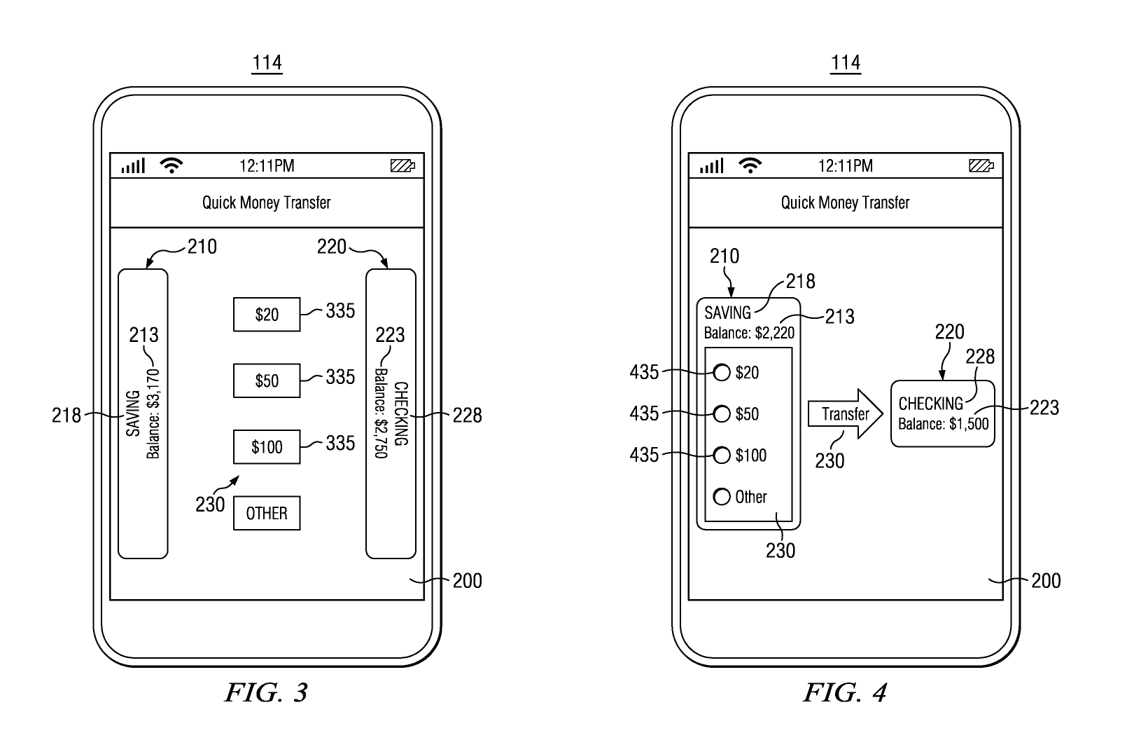

FIG. 3 illustrates an embodiment of a mobile device 114 used in FIG. 1. As in the previous figure, the third region 230 of display 200 lies in between the first region 210 and the second region 220 of display 200. In this embodiment, mobile device 114 presents buttons corresponding to the plurality of transfer amounts 335. User 112 may indicate a selection of a particular transfer amount 335 by touching the portion of display 200 presenting a button corresponding to that transfer amount 335. For example, user 112 may select to transfer $20 by touching the portion of display 200 that presents the button corresponding to the $20 transfer amount. When mobile device 114 detects that user has touched the portion of the display 200 that presents a button corresponding with a particular transfer amount 335, mobile device 114 may determine whether there are sufficient funds to perform the transfer. If there are sufficient funds, mobile device 114 may initiate the transfer as previously described.

FIG. 4 illustrates an embodiment of a mobile device 114 used in FIG. 1. In this embodiment, the third region 230 of display 200 overlaps the first region 210 of display 200. Furthermore, mobile device 114 presents radio buttons corresponding to the plurality of transfer amounts 435. User 112 may select a particular transfer amount 435 by touching a portion of display 200 on or around a radio button corresponding to the particular transfer amount 435. After user 112 indicates the selection, the radio button corresponding to that selection may be darkened or filled to indicate the selection of the particular transfer amount 435. For example, if user 112 touches the portion of display 200 corresponding to the radio button for the transfer amount $50, that radio button may be filled to indicate user's 112 selection. If user 112 then touches the portion of display 200 corresponding to the radio button for the transfer amount $100, that radio button may be filled and the radio button for $50 may be emptied.

Mobile device 114 further presents an arrow pointing from the first region 210 to the second region 220. In particular embodiments, use 112 may additionally touch the portion of display 200 that presents the arrow to indicate that user 112 desires to initiate the transfer of the particular transfer amount 435 from the first account to the second account. For example, after user 112 selects the $50 transfer amount, the radio button corresponding to that amount may be filled. Then user 112 may touch the portion of the display 200 corresponding to the arrow to begin initiating the transfer. In other embodiments, user's 112 selection of the transfer amount by touching a portion of display 200 that presents the radio button corresponding to that transfer amount may indicate that user 112 desires to initiate the transfer of the particular transfer amount 435 from the first account to the second account.

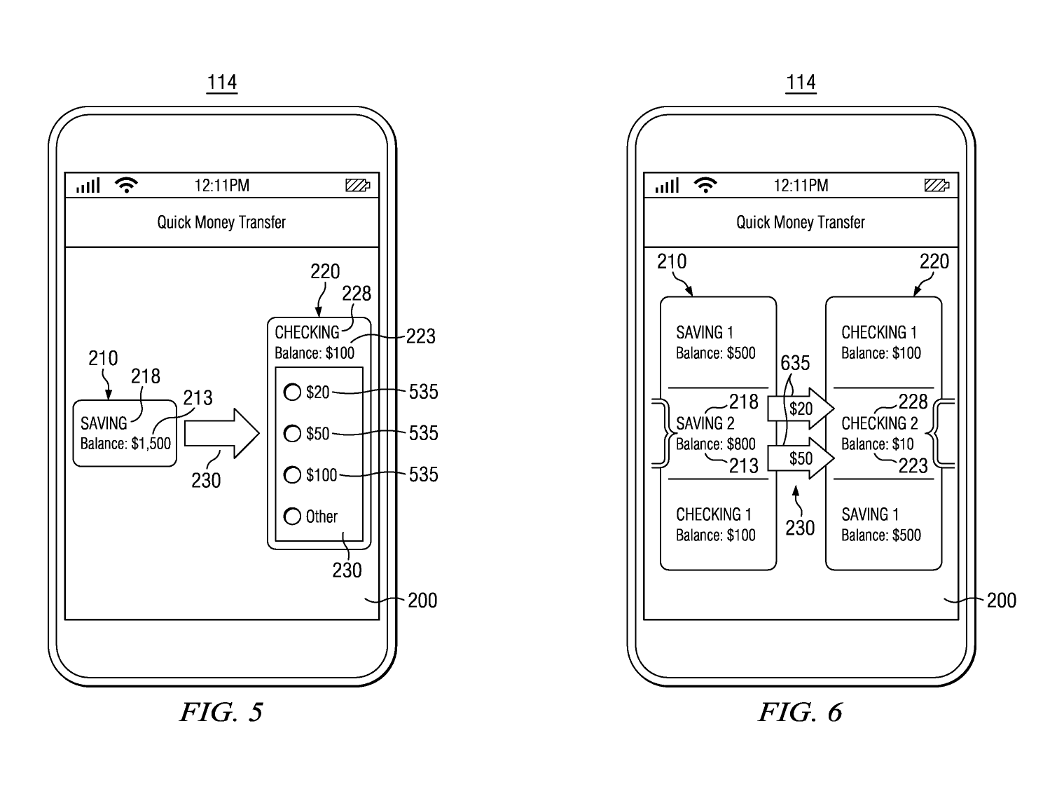

FIG. 5 illustrates an embodiment of the device 114 of FIG. 1. In this embodiment, the third region 230 of display 200 overlaps the second region 220 of display 200. As described previously, display 200 presents a plurality of transfer amounts 535 and corresponding radio buttons. User 112 can select a particular transfer amount 535 by touching a portion of display 200 that presents the radio button corresponding to the particular transfer amount 535. As in the example illustrated in FIG. 4, the embodiment of FIG. 5 also presents an arrow in the third region 230 of display 200. The arrow may operate similarly to the arrow presented in FIG. 4. The example illustrated in FIG. 5 may operate similar to the example illustrated in FIG. 4.

FIG. 6 illustrates an embodiment of the device 114 of FIG. 1. In this embodiment, the third region 230 of display 200 overlaps both the first region 210 and the second region 220 of display 200. As previously shown, device 114 may present arrows corresponding to the transfer amounts 635. User 112 may indicate that user 112 desires to transfer a particular transfer amount from the first account to the second account by swiping over an arrow corresponding to the particular transfer amount 635.

In particular embodiments, user 112 may change the first account 140a and the second account 140b by touching the first region 210 and the second region 220. In the example illustrated in FIG. 6, user 112 may change the first account 140a and second account 140b by swiping vertically on the first region 210 and the second region 220. For example, user 112 may change the first account 140a from saving 2 to saving 1 by swiping downward on the first region 210. Similarly, user 112 may change the second account 140b from checking 2 to saving 1 by swiping upward on the second region 220. If device 114 detects the swipe indicating a change of accounts 140, device 114 may update a display to present the switch in accounts 140. For example, device 114 may update the display to present the new account 140 as the selected account 140 by presenting a scrolling animation in the region of display 200 presenting the accounts 140.

In other embodiments, user 112 may change the first account 140a and the second account 140b by touching the first region 210 and the second region 220 respectively. In the examples illustrated in FIGS. 2 through 5, user 112 may touch the first region 210 of display 200. Mobile device 114 may update the display 200 to present a list of accounts 140 that user 112 may select. User 112 may select a particular account 140 by touching the portion of display 200 that presents the account 140. After the selection, device 114 may update the display 200 to present information associated with the selected account 140 in the first region 210. For example, after the selection, device 114 may present on the display 200 an account type and a balance associated with the new account 140 in the region of the display 200 that displayed the original account.

In particular embodiments, device 114 may be configured to present balance notifications and alerts. For example, user 112 may configure device 114 to present a balance alert whenever a balance of a checking account of user 112 falls below a particular threshold. When device 114 detects that the balance of the checking account is below the threshold, device 114 may update the display 200 to present an alert to the user 112 indicating that the user should transfer funds to the checking account. User 112 may then use device 114 to quickly transfer funds to the checking account. In this manner, user 112 may be quickly notified of low balances and quickly remedy the low balances by transferring funds. For example, device 114 may be configured to present a balance alert whenever a checking account of user 112 falls below $20. When device 114 detects that the checking account has fallen below $20, the device may present an alert to user 112. Device 114 may additionally vibrate or make a sound in order to make user 112 aware of the alert. User 112 may respond to the alert by using device 114 to transfer a balance to his checking account.

In particular embodiments, device 114 may present accounts 140 that are not associated with user 112. Device 114 may allow user 112 to quickly transfer funds to an account of another user 112. For example, user 112 may use device 114 to transfer funds from the user's 112 saving account to the checking account of a friend. Device 114 may limit the presentation of information associated with the account 140 of the other user 112. For example, device 114 may not present the balance of the account 140 of the other user 112. As another example, device 114 may not present the account type of the account 140 of the other user 112. In this manner, user 112 may use device 114 to quickly transfer funds to an account of another user 112.

FIG. 7 is a flowchart illustrating a method 700 of transferring balances between accounts. Mobile device 114 may perform method 700. In particular embodiments, mobile device 114 may execute an application 190 that causes mobile device 114 to perform method 700. In step 705 mobile device 114 may present a first account in a first region 210 of a display 200. In step 710 mobile device 114 may present a second account in a second region 220 of the display 200. In step 715 mobile device 114 may present a plurality of transfer amounts 235 in a third region 230 of the display 200. In particular embodiments, the third region 230 may lie in between the first region 210 and the second region 220. In other embodiments, the third region 230 may overlap the first region 210, the second region 220, or both the first region 210 and the second region 220.

In step 720 mobile device 114 may detect a touch on the third region 230 indicating a selection of a transfer amount 235. In particular embodiments, the touch may be a swipe. In step 725 mobile device 114 may determine if there are sufficient funds in the first account to perform the transfer. If there are not sufficient funds, mobile device 114 may conclude by updating the display 200 to indicate that there are insufficient funds to perform the transfer in 730.

If there are sufficient funds, mobile device 114 may continue to step 735 to initiate the transfer. As an example and not by way of limitation, mobile device 114 may communicate a message 180 to server 110 through network 120 to initiate the transfer. Mobile device 114 may then conclude in step 740 by receiving a confirmation message 170 indicating the transfer succeeded. In particular embodiments, mobile device 114 may receive the confirmation message 170 from server 110 through network 120.

By performing method 700, mobile device 114 may provide several technical advantages. For example, mobile device 114 may reduce the load on network 120.

Furthermore, by executing application 190, mobile device 114 may reduce the amount of processing power needed to perform balance transfers.

Although the present disclosure includes several embodiments, a myriad of changes, variations, alterations, transformations, and modifications may be suggested to one skilled in the art, and it is intended that the present disclosure encompass such changes, variations, alterations, transformations, and modifications as fall within the scope of the appended claims.

What is claimed is:

1. An apparatus comprising:
a memory operable to store a plurality of accounts, each account associated with an account type and a balance; and
a processor communicatively coupled to the memory and operable to:
present, in a first region of a display, a first account type and a first balance associated with a first account in the plurality of accounts;
present, in a second region of the display, a second account type and a second balance associated with a second account in the plurality of accounts;
present, in a third region of the display, a plurality of transfer amounts, wherein the third region of the display lies between the first area and the second area of the display;
detect a first swipe on the third area of the display indicating a selection of a transfer amount from the plurality of transfer amounts;
determine, in response to the detection of the first swipe, that the first balance is at least equal to the selected transfer amount;
communicate, in response to the determination that the first balance is at least equal to the selected transfer amount, a message to initiate the transfer of the selected transfer amount from the first account to the second account;
receive a second message indicating that the selected transfer amount has been transferred from the first account to the second account;
update, in response to receiving the second message, the display to indicate that the selected transfer amount has been transferred from the first account to the second account;
detect a second swipe on the first region of the display indicating a switch from the first account to a third account in the plurality of accounts; and
update the display to present a third account type and a third balance associated with the third account in the first region of the display in response to the detection of the second swipe.

2. An apparatus comprising:
a memory operable to store a plurality of accounts; and
a processor communicatively coupled to the memory operable to:
present, in a first region of a display, information associated with a first account in the plurality of accounts;
present, in a second region of the display, information associated with a second account in the plurality of accounts;
present, in a third region of the display, a plurality of transfer amounts;
detect a touch on the third region of the display indicating a selection of a transfer amount from the plurality of transfer amounts; and
communicate, in response to the detection of the touch, a message to initiate the transfer of the selected transfer amount from the first account to the second account.

3. The apparatus of claim 2, wherein the processor is further operable to:
determine, in response to the detection of the touch, that a balance associated with the first account is at least equal to the selected transfer amount; and
communicate the message further in response to the determination that the balance is at least equal to the selected transfer amount.

4. The apparatus of claim 2, wherein the processor is further operable to:
detect a second touch on the first region of the display indicating a switch from the first account to a third account in the plurality of accounts; and
update, in response to the detection of the second touch, the display to present, in the first region of the display, information associated with the third account.

5. The apparatus of claim 2, wherein the processor is further operable to:
determine that a balance associated with the first account is less than the selected transfer amount; and
update, in response to the determination that the balance is less than the selected transfer amount, the display to indicate that the selected transfer amount cannot be transferred from the first account.

6. The apparatus of claim 2, wherein:
the memory is further operable to store frequent transactions; and
the processor is further operable to determine the first account and the second account based at least in part upon the frequent transactions.

7. The apparatus of claim 2, wherein the processor is further operable to:
determine that a balance associated with the second account is below a threshold; and
update the display to indicate that the balance associated with the second account is below the threshold.

8. The apparatus of claim 2, wherein the processor is further operable to:
receive a second message indicating that the selected transfer amount has been transferred from the first account to the second account; and
update, in response to receiving the second message, the display to indicate that the selected transfer amount has been transferred from the first account to the second account.

9. The apparatus of claim 2, wherein the third region of the display lies between the first region and the second region of the display.

10. The apparatus of claim 2, wherein at least a portion of the third region of the display overlaps at least a portion of the first region of the display.

11. The apparatus of claim 2, wherein at least a portion of the third region of the display overlaps at least a portion of the first region and at least a portion of the second region of the display.

12. The apparatus of claim 2, wherein at least a portion of the third region of the display overlaps at least a portion of the second region of the display.

13. The apparatus of claim 2, wherein the touch comprises a swipe in a direction from the first region of the display to the second region of the display.

14. The apparatus of claim 13, wherein the processor is further operable to present, in the third region of the display, an indicator for the direction of the swipe.

15. The apparatus of claim 2, wherein the first account and second account are associated with different users.

16. A method comprising:
storing a plurality of accounts;
presenting, in a first region of a display, information associated with a first account in the plurality of accounts;
presenting, in a second region of the display, information associated with a second account in the plurality of accounts;
presenting, in a third region of the display, a plurality of transfer amounts;
detecting a touch on the third region of the display indicating a selection of a transfer amount from the plurality of transfer amounts; and
communicating, in response to the detection of the touch, a message to initiate the transfer of the selected transfer amount from the first account to the second account.

17. The method of claim 16 further comprising:
determining, in response to the detection of the touch, that a balance associated with the first account is at least equal to the selected transfer amount; and
communicating the message further in response to the determination that the balance is at least equal to the selected transfer amount.

18. The method of claim 16 further comprising:
detecting a second touch on the first region of the display indicating a switch from the first account to a third account in the plurality of accounts; and
updating, in response to the detection of the second touch, the display to present, in the first region of the display, information associated with the third account.

19. The method of claim 16 further comprising:
determining that a balance associated with the first account is less than the selected transfer amount; and
updating, in response to the determination that the balance is less than the selected transfer amount, the display to indicate that the selected transfer amount cannot be transferred from the first account.

20. The method of claim 16 further comprising:
storing frequent transactions; and
determining the first account and the second account based at least in part upon the frequent transactions.

21. The method of claim 16 further comprising:
determining that a balance associated with the second account is below a threshold; and
updating the display to indicate that the balance associated with the second account is below the threshold.

22. The method of claim 16 further comprising:
receiving a second message indicating that the selected transfer amount has been transferred from the first account to the second account; and
updating, in response to receiving the second message, the display to indicate that the selected transfer amount has been transferred from the first account to the second account.

23. The method of claim 16, wherein the third region of the display lies between the first region and the second region of the display.

24. The method of claim 16, wherein at least a portion of the third region of the display overlaps at least a portion of the first region of the display.

25. The method of claim 16, wherein at least a portion of the third region of the display overlaps at least a portion of the first region and at least a portion of the second region of the display.

26. The method of claim 16, wherein at least a portion of the third region of the display overlaps at least a portion of the second region of the display.

27. The method of claim 16, wherein the touch comprises a swipe in a direction from the first region of the display to the second region of the display.

28. The method of claim 27 further comprising presenting, in the third region of the display, an indicator for the direction of the swipe.

29. The method of claim 16, wherein the first account and second account are associated with different users.

30. One or more computer-readable non-transitory storage media embodying software that is operable when executed to:
store a plurality of accounts;
present, in a first region of a display, information associated with a first account in the plurality of accounts;
present, in a second region of the display, information associated with a second account in the plurality of accounts;
present, in a third region of the display, a plurality of transfer amounts;
detect a touch on the third region of the display indicating a selection of a transfer amount from the plurality of transfer amounts; and
communicate, in response to the detection of the touch, a message to initiate the transfer of the selected transfer amount from the first account to the second account.

31. The one or more computer-readable non-transitory storage media of claim 30 embodying software that is further operable when executed to:
determine, in response to the detection of the touch, that a balance associated with the first account is at least equal to the selected transfer amount; and
communicate the message further in response to the determination that the balance is at least equal to the selected transfer amount.

32. The one or more computer-readable non-transitory storage media of claim 30 embodying software that is further operable when executed to:
detect a second touch on the first region of the display indicating a switch from the first account to a third account in the plurality of accounts; and
update, in response to the detection of the second touch, the display to present, in the first region of the display, information associated with the third account.

33. The one or more computer-readable non-transitory storage media of claim 30 embodying software that is further operable when executed to:
determine that a balance associated with the first account is less than the selected transfer amount; and
update, in response to the determination that the balance is less than the selected transfer amount, the display to indicate that the selected transfer amount cannot be transferred from the first account.

34. The one or more computer-readable non-transitory storage media of claim 30 embodying software that is further operable when executed to:
store frequent transactions; and
determine the first account and the second account based at least in part upon the frequent transactions.

35. The one or more computer-readable non-transitory storage media of claim 30 embodying software that is further operable when executed to:
determine that a balance associated with the second account is below a threshold; and
update the display to indicate that the balance associated with the second account is below the threshold.

36. The one or more computer-readable non-transitory storage media of claim 30 embodying software that is further operable when executed to:
receive a second message indicating that the selected transfer amount has been transferred from the first account to the second account; and
update, in response to receiving the second message, the display to indicate that the selected transfer amount has been transferred from the first account to the second account.

37. The one or more computer-readable non-transitory storage media of claim 30, wherein the third region of the display lies between the first region and the second region of the display.

38. The one or more computer-readable non-transitory storage media of claim 30, wherein at least a portion of the third region of the display overlaps at least a portion of the first region of the display.

39. The one or more computer-readable non-transitory storage media of claim 30, wherein at least a portion of the third region of the display overlaps at least a portion of the first region and at least a portion of the second region of the display.

40. The one or more computer-readable non-transitory storage media of claim 30, wherein at least a portion of the third region of the display overlaps at least a portion of the second region of the display.

41. The one or more computer-readable non-transitory storage media of claim 30, wherein the touch comprises a swipe in a direction from the first region of the display to the second region of the display.

42. The one or more computer-readable non-transitory storage media of claim 41 embodying software that is further operable when executed to present, in the third region of the display, an indicator for the direction of the swipe.

43. The one or more computer-readable non-transitory storage media of claim 30, wherein the first account and second account are associated with different users.
